(19) United States
(12) Patent Application Publication
(10) Pub. No.: US 2004/0042593 A1
(43) Pub. Date: Mar. 4, 2004

(54) Web-based telephony services creation, deployment and maintenance method and system

(76) Inventors: Suren Gulrajani, Chester Springs, PA (US); Ratna Shah, Chester Springs, PA (US)

Correspondence Address: RATNERPRESTIA, P O BOX 980, VALLEY FORGE, PA, 19482-0980, US

(21) Appl. No.: 10/440,812

(22) Filed: May 19, 2003

Related U.S. Application Data
(60) Provisional application No. 60/381,491, filed on May 17, 2002.

(51) Int. Cl. H04M 11/00

(52) U.S. Cl. 379/88.18

(57) ABSTRACT

A interactive voice response system includes a user interface having a plurality of icons each icon representing a respective interactive voice response (IVR) function and editor. The editor is configured to allow a tree structure to be built by graphic manipulation of the icons. The tree structure defines a sequence of IVR functions to be executed by an IVR system. an application generator, is responsive to the tree structure defined using the editor to generate a voice extended markup language (voiceXML) representation of the sequence of IVR functions represented by the tree. The voiceXML representation of the sequence is transferred to a voiceXML server for execution.

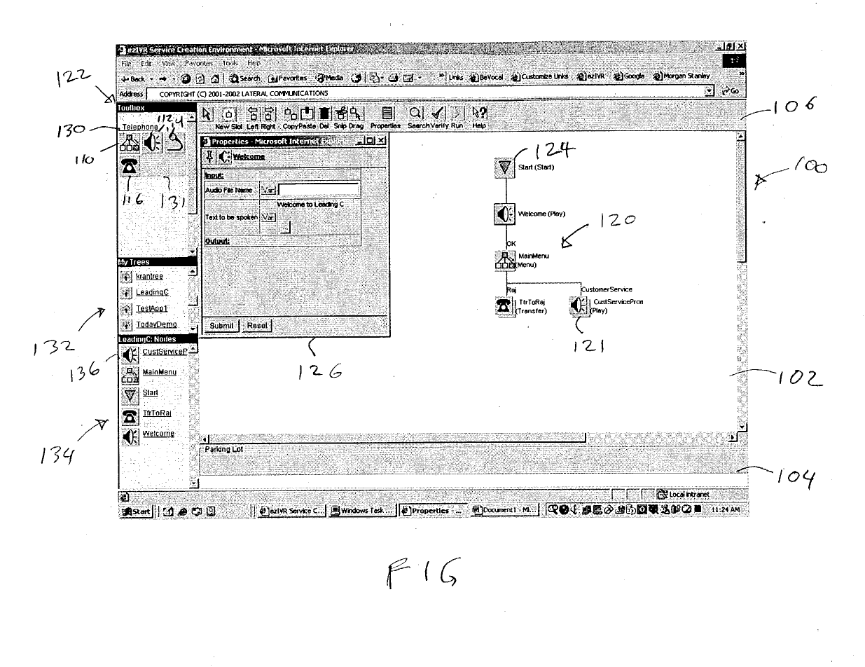

### CROSS-REFERENCE TO RELATED APPLICATIONS

This application claims the benefit of U.S. Provisional Application No. 60/381,491, filed May 17, 2002, the contents of which are incorporated herein by reference.

### FIELD OF THE INVENTION

The present invention concerns interactive telephony services and in particular, a method for creating, deploying and maintaining interactive telephony services using a global information network (e.g. the Internet).

### SUMMARY OF THE INVENTION

A interactive voice response system includes a user interface having a plurality of icons each icon representing a respective interactive voice response (IVR) function and editor. The editor is configured to allow a tree structure to be built by graphic manipulation of the icons. The tree structure defines a sequence of IVR functions to be executed by an IVR system. an application generator, is responsive to the tree structure defined using the editor to generate a voice extended markup language (voiceXML) representation of the sequence of IVR functions represented by the tree.

### BRIEF DESCRIPTION OF THE DRAWING

The FIGURE is a screen-shot of a user interface suitable for use with the subject invention that is useful for describing features of the invention.

### DETAILED DESCRIPTION

The present invention is embodied in a software system known as ezIVR. This system implements an innovative, web based, rapid Telephony Service Creation, Deployment and Maintenance environment. The User Interface of ezIVR is based on an Internet browser and can be accessed from any Internet browser such as Microsoft Internet Explorer, Netscape, etc. The ezIVR User Interface is designed so that it does not require detailed knowledge of interactive voice response (IVR) systems or detailed knowledge of computer hardware or software. The interface is highly intuitive and simple to use. Users require little or no Telephony expertise to be able to build, deploy and use ezIVR Applications.

Further, no special on-site, customer premise equipment is required to deploy and run ezIVR telephony applications. ezIVR applications run on sophisticated remote voice servers, and users are relieved of the technical and operational issues of acquiring, installing and maintaining such servers. Ultimately from a user's perspective, all that is required to build and run ezIVR telephony application is a PC with an internet connection.

The following are some examples of the types of applications that can be built using ezIVR:

Phone based customer self-service applications (check account balances, order tracking, etc.)

customized notification services, etc.)

Voice eCommerce applications (Phone based order processing, Credit Card transactions, bill payment, store fronts, etc.)

Voice Portal applications (News, Stock Quotes, Airline flight arrivals, Weather, Directions, Location based services, etc.)

Personal Telephony applications (Voice Mail Account aggregation, follow-me, Personal IVRs, etc)

The ezIVR architecture comprises the following major components: a user interface, an application generator, a database, a set of functions and a telephony web-based server.

ezIVR Browser Based User Interface:

The exemplary user interface is a web browser based GUI environment where uses can build, modify, customize, deploy and monitor their ezIVR applications. The FIGURE is a screen-print of an exemplary user interface according to the subject invention. The ezIVR applications are built using ezBlocks (e.g. items 110, 112, 114 and 116 in the FIGURE). The ezBlocks are a high level abstractions of functions such as “play a prompt”, “record a voice message”, “dial a number” etc. Users are presented with a rich collection of ezBlocks that they can drag and drop and move around to create an ezIVR Tree 120. An ezIVR Tree is a collection of ezBlocks in a connected form, that defines a sequence in which the functions are to be executed when the application is running and processing calls. The User Interface of ezIVR provides several intuitive operations such as drag, drop, select, cut, paste, copy, delete, and snip on the ezBlock functions. These operations make it easy for a user to manipulate and quickly build ezIVR Trees. An ezIVR Tree can be a complete application by itself. Alternatively, several ezIVR Trees can be connected together to form an ezIVR application.

ezIVR Application Generator:

Once a user has built an ezIVR Tree using the user interface, the ezIVR application generator analyzes the ezBlocks used and the tree structure and automatically generates a telephony application in VoiceXML that can be run on any VoiceXML compliant Telephony Web Server. The ezIVR application generator handles several programming aspects for the application such as function definitions, parameter declarations, initialization and parameter passing across functions, subdialogs and applications. The ezIVR Application Generator uses the ezBlock VoiceXML template code to generate VoiceXML code for the entire application.

ezIVR Database

The exemplary ezIVR system uses a structured query language (SQL) server database to hold the data for the following logical entities:

ezIVR ezBlocks definitions

ezIVR Trees, connection structures

ezIVR Applications

ezIVR application variables, parameter definitions and parameter values

ezIVR User Interface environment parameters

ezIVR User/Subscriber information

In the exemplary embodiment of the invention, the ezIVR database is used as follows:

by the ezIVR User Interface to read/write user created trees, applications, parameters and variables as the user creates or modifies any trees or applications. The User Interface also uses the database to store User Information for registration and login authentication.

by the ezIVR application generator to read the tree structures and parameters and generate the ezIVR VoiceXML scripts and applications.

ezIVR ezBlock Functions

The functions used by users to build ezIVR trees are encapsulated within ‘ezBlocks’. Each ezBlock is represented on the User Interface as a graphical icon 110, 112, 114 and 116 in the Toolbar 122, and can be dragged, dropped, copied, cut or pasted into the ezIVR Tree 120 to build an ezIVR application. EzBlocks can represent primitive functions such as ‘Play a prompt’ or they can represent entire complex applications such as a ‘Voice Activated Dialing’ application. EzBlocks have associated scripts that are used by the ezIVR application Generator to build the ezIVR application. These scripts are not generally exposed to the users in the User Interface.

An ezBlock can have one or more associated input/output parameters. These parameters may be assigned static values while building the tree, or the user can specify the values to be taken from specific variables at run time.

A unique feature of ezIVR is the ability to create new ezBlocks and use them instantly; all from within the same ezIVR browser based User Interface. This feature allows for a tremendous flexibility and higher productivity for power users. Referring to the FIGURE, the tree 120 may be designated as an ezBlock, assigned a name and an icon and added to the toolbox 122. This ezBlock may be used by other applications which are generated as trees in the user interface 100.

Telephony Web Server

The telephony Web Server is the physical server that connects to the telephone network (PSTN) and also to the Internet. The ezIVR applications run on this server. Because the ezIVR system is designed to generate industry-standard VoiceXML applications, virtually any telephony Web server that is VoiceXML compliant can serve as the Telephony Web server for running ezIVR applications. When the users ‘activate’ their ezIVR application, the automatically generated VoiceXML application is linked to a specific Telephony Web Server and it is then ready to take calls arriving at the phone number(s) assigned to the user.

Browser Based User Interface

The ezIVR User Interface 100 is completely web browser based and allows users to create, modify and deploy (activate) their ezIVR applications from any internet browser such as Microsoft Internet Explorer, Netscape, etc.

The different components of the User Interface are described in the following sections.

Toolbar

The Toolbar 122 is a DHTML frame that displays all the different ezBlocks available to the users for building their ezIVR applications. The ezBlocks are classified into different categories and each category can be collapsed or expanded individually. Examples of Categories are: Basic Telephony Functions 130, Personal Applications 131, eCommerce Applications (not shown), etc. When collapsed, only the category name (e.g. “Telephone” 130) is shown as a hyperlink. Clicking on the hyperlink expands the category. When expanded, the icons (e.g. 110, 112, 114 and 116) for each ezBlock within the category (e.g. Personal Applications) are displayed in the Toolbar frame.

In the exemplary embodiment, the complete details, including the images for each ezBlock are sent from the server to the ezIVR browser client when the user first starts editing a tree. The details are sent in an XML island, along with the supporting functions to render the XML island into appropriate DHTML for viewing and manipulation.

A partial list of the ezBlock functions is given in Table 2 below. A detailed description of each of the ezBlock functions is given in the Appendix.

Editor

The Editor 102 is the main, central DHTML frame in the ezIVR User Interface 100. The editor 102 is the frame in which the actual ezIVR tree 120 is built and edited. When a new tree is started, the editor presents the user with a “start” cell 121, followed by an open slot (not shown). The start cell 121 represents the starting point for the ezIVR application. The user builds the application further by adding (i.e. dragging and dropping) a new ezBlock in the open slot following the START block. Each ezBlock executes a specific function and returns a specific result. The same ezBlock can return different results depending on the execution context and input from the caller at run-time. While building the tree 120 in the Editor 102, the user is shown a list (not shown in the FIGURE) of possible results that an ezBlock may return. The user can add new results to this list or can choose to handle only a subset of the listed results.

Drag and Drop:

A user builds an ezIVR application tree by selecting an ezBlock (e.g. 110, 112, 114 or 116) from the Toolbar 122, and dragging it to an open slot in the Editor 102. An ezBlock function may be selected, for example, by clicking once on the associated icon in the Toolbar 122, Editor 102 or the CurrentTreeNodesList 134 frames. Once an ezBlock is selected, it will automatically be “dragged” when the cursor is moved across the screen. While being ‘dragged’ the image of the ezBlock follows the cursor. Finally, the ezblock is ‘dropped’ by positioning the ‘drag’ cursor in an open slot and clicking once. This ‘drag and drop’ functionality within the internet browser is an innovative feature of ezIVR that is implemented using programming algorithms described in the attached Appendix.

Whenever a new ezBlock function is inserted in the tree, an Identification dialog box (not shown) for that ezBlock function is automatically presented to the user. The user specifies some basic information for the ezBlock function in the Identification dialog box: a name, description and the results to be handled by that ezBlock. The Editor then automatically provides open slots for each result specified for the ezBlock. These slots may then be populated with new ezBlock functions as desired by the user.

Once an ezBlock function is inserted in a slot, the user may specify several parameters for that ezBlock function by selecting the ezBlock function and clicking on the ‘Properties’ button in the Commands frame (not shown). This opens a new dialog box 126 that presents the parameters for the selected ezBlock function and the user can provide appropriate values for these parameters.

MyTrees List

The MyTrees List 132 is a DHTML frame in the ezIVR User Interface. This frame displays the list all the trees (ezIVR Applications) for the current logged-on User. Each tree is displayed as a hyperlink along with an icon of a tree. On clicking the hyperlink for a tree, the full tree is displayed in the Editor frame.

Nodes List

The Nodes list 134 is a DHTML frame in the ezIVR User Interface. This frame displays the list of all the nodes for the current tree (the tree displayed in the Editor frame). Each node is displayed as a hyperlink, along with the icon of its corresponding ezBlock.

The Nodes list 134 is a ‘hot’ list: any actions or operations performed on a node (e.g. 138) within the Nodes list frame 134 is immediately reflected in the Editor frame 102. For example, if a node (e.g. 136) is deleted in the nodes list, the corresponding node (e.g. 121) in the tree 120 is deleted and this change is immediately reflected in the tree 120 displayed in the Editor frame 102. Nodes in the Node list 134 can be dragged and dropped into empty slots in the current tree 120 in the Editor frame 102. This creates a ‘link’ or a ‘jump to’ operation at that slot in the tree. At runtime, when that node is encountered, the application flow will be transferred to the appropriate point represented by that node in the tree.

Parking Lot

The Parking Lot 104 is a DHTML frame in the ezIVR User Interface 100. The Parking Lot 104 provides a ‘parking’ area for certain Nodes to assist in navigating the tree. The User can drag and drop any node from the tree 120 to the Parking Lot 104. The node is then visible in the Parking Lot till the user explicitly removes it from there. Nodes in the Parking Lot are ‘hot’ just as the nodes in the Nodes list 134. Once a node is parked in the Parking Lot 104, it serves as a shortcut to the actual point in the tree 120 where that node is defined. Nodes parked in the Parking Lot can be dragged to empty slots in the tree to create ‘links’ (see description of ‘links’ in Nodes List section, above).

Commands (Actions)

‘Commands’ is a DHTML frame 106 in the ezIVR User Interface 100. This frame displays buttons for various actions that can be performed on the tree or nodes of the tree displayed in the Editor frame. The following Table lists the various actions implemented in the Commands frame.

TABLE 1

| Action | Description |
|---|---|
| Home | Deselects any currently selected slot or ezBlock and shift |
| | the focus from any other frame to the commands frame. |
| New Slot | Creates a new empty slot at the currently selected node |
| Left | Shifts the currently selected node one slot to the left |
| Right | Shifts the currently selected node one slot to the right |
| Copy | Makes a copy (in an internal buffer) of the currently |
| | selected node |
| Paste | Pastes a copy of the node including all associated data and |
| | parameters, from the internal copy buffer to the selected |
| | location (node) |
| Delete | Permanently deletes the currently selected node from the |
| | tree |
| Snip | Disconnects the selected node from its parent node at the |
| | point where it is selected. The disconnected node continues |
| | to exist in the tree and is still displayed in the Nodes list. If |
| | this node is linked to another parent node(s) at any other |
| | point in the tree, it will continue to remain connected at |
| | that point(s). If there is no other parent(s) for this node, it |
| | will continue to exist as an orphan node till it is deleted. |
| Drag | Starts dragging the selected node in the tree. This action is |
| | required to drag a node from the tree to the Parking Lot |
| Properties | Displays the Properties dialog box for the currently |
| | selected node. If no node is selected, clicking on this |
| | button will display the Properties dialog box for the entire |
| | Tree. Refer to the section on the Properties Dialog for |
| | further details. |
| Search | Displays a Search dialog box that allows the user to search |
| | for specific nodes, strings and other parameters within the |
| | tree. |
| Verify | Runs verification for the entire tree to validate the nodes, |
| | connections and parameters of all the nodes in the tree. |
| | This process is intended to alert the user of any |
| | inconsistencies in the tree structure or parameters and |
| | reduce the chances for run time errors. |
| Run | Triggers the ezIVR VoiceXML application generator to |
| | generate the entire application for the current tree. After |
| | the application is created, it is automatically activated, |
| | installed and launched at the Telephony Web Server. |
| Help | Provides help information. |

VoiceXML Application Generator

The ezIVR VoiceXML application generator (not shown) is a module within ezIVR that takes the graphical tree created by the user and converts it into a regular VoiceXML application. This VoiceXML application can then be run on any VoiceXML compliant telephony platform. Further details about the ezIVR VoiceXML application generator are described in the Appendix.

ezBlocks (Partial List)

An ezBlock is a modular unit representing a logical function that can be performed when a phone call is in progress. A phone call interaction between a caller and an ezIVR application consists of a sequence of ezBlocks being executed. The sequence of ezBlocks functions being executed is determined by the structure of the ezIVR Tree 120 built by the user.

Each ezBlock function has some VoiceXML code associated with it. The VoiceXML code may make further calls to other programs or resources on the server or on the web, as allowed by the standard VoiceXML specification. Further, each ezBlock function can have Parameters and Variables associated with it (see section on Parameters and Variables below). The VoiceXML code and the Parameters and Variables associated with an ezBlock are automatically incorporated in the final ezIVR application generated by the ezIVR VoiceXML generator.

Some Examples of ezBlocks are given in Table 2

TABLE 2
Playback a recording
Record a Message
Play a menu of choices to the caller and collect the choice (as a DTMF
tone or a spoken word/phrase)
Perform Voice Activated Dialing (dial a number associated with a spoken
name, and associated maintenance functions, store lists of names and
numbers, etc.),

User-Defined ezBlocks

ezIVR allows users to define their own ezBlocks. This is also done on the ezIVR User Interface. In order to do this, users define the input and output parameters for the ezBlock, and specify an icon that is to be used to represent that ezBlock. The users must also write the relevant VoiceXML code that is to be executed when the ezBlock is encountered at runtime. ezIVR then displays the ezBlock icon in the Toolbar and the users can use the ezBlock in their ezIVR Trees. The ezIVR VoiceXML generator automatically includes the VoiceXML code associated with the ezBlock in the appropriate place(s) in the final generated application.

Promoting ezIVR Applications as ezBlocks

One of the unique features of ezIVR is the ability to promote an entire ezIVR application as an ezBlock. When an ezIVR application is promoted as an ezBlock, the entire application is represented graphically in the User Interface as a single icon or ezBlock, in the Toolbar. This allows other users to include and execute the specified ezIVR Application within their ezIVR trees just as they would use any other ezBlock.

Parameters and Variables

Each ezBlock can have input and output parameters associated with it. An input parameter must be filled in prior to executing the ezBlock, and the ezBlock populates an output parameter after it has executed. Further, input and output parameters can be populated with ‘static’ values when the tree is being created or these can get values dynamically at run time, from ‘variables’.

‘Variables’ are temporary storage locations that can hold data/values while the ezIVR application is active. Variables are defined by users, to be able to temporarily store certain values and pass them across ezBlocks. The values from Variables can be used anywhere within an ezIVR Tree. The values in Variables can be passed as the input parameters to ezBlocks at run time, and Variables can also be specified as receiving locations for the output parameters of ezBlocks.

Parameter and variable definitions for ezBlocks and ezIVR trees are maintained by ezIVR in the database, and are managed by ezIVR at runtime.

From the design perspective, there are two types of ezBlocks: Primitive and Composite. Primitive ezBlocks represent basic unit functions such as playing a prompt or recording a message. Composite ezBlocks comprise a set of call-flows or one or more ezIVR trees represented as a single high-level function, for example—“perform Voice Activated Dialing” or “Fill in a voice form”.

From a User's perspective, both Primitive and Composite ezBlocks are used in the same way—they are simply dragged from the Toolbar and placed in the desired slot in the ezIVR Tree.

Primitive ezBlocks

The following are exemplary primitive ezBlock functions that may be used in an exemplary embodiment of the present invention.

Play

Play a recorded prompt if specified, otherwise converts specified text to speech and plays the converted text as speech

Record

Records a voice message and stores it in a specified location such as a file.

Menu

Sets up a menu of options for caller to select from. The user (person who is building the tree) can specify the options, and associate a word or phrase for each option. The ezIVR system automatically generates the prompt to be played when the menu is encountered, based on the specified option or phrase.

Several different menu styles are provided, allowing for different combinations of speech, DTMF or both as methods for selecting the menu options.

An ‘Advanced’ option is provided for users to build more sophisticated menus using custom grammars.

Initiate Call

Initiates an outbound call to a specified phone number

Transfer Call

While an incoming call is in progress, dials another number and connects the incoming call to the dialed number.

End

This represents the termination point of the ezIVR application and the caller is disconnected when this ezBlock is encountered.

Collect Digits

This ezBlock collects a sequence of DTMF digits from the caller, based on the selected Digit Collection Rule. A Digit Collection Rule specifies details of how the digit collection is to be done. Examples of Digit Collection Rules:

“Single”: Collect a single digit

“Fixed Length”: Collects the specified number of digits

“Variable Length”: Collects a variable number of digits, terminated by a ‘delimiter’ digit, typically the ‘#’ digit

Data Storage

This ezBlock allows the User to create, access, populate, modify or delete a data store. A Data Store is a logical representation of a flexible, permanent storage area. Users can use Data Stores to save the voice recordings or DTMF input digits collected during course of a call. The data stored in these data stores is retained permanently until the user chooses to delete it. The data in data stores is identified by user-defined identifiers specified when the data is first stored. The data can be retrieved using this identifier.

Composite ezBlocks

The following are examples of composite exBlocks.

Voice Activated Dialing

This ezBlock encapsulates a complete Voice Activated Dialing application, including the associated call flows for guiding the caller to specify a name to dial, associating names with numbers, setting up directories of names/numbers, etc. This ezBlock exposes a number of parameters that can be set by Users to control the behavior of the application. It also allows Users to add names/numbers to their Voice Activated Dialing Directories, or to import the name/numbers from an external source such as a PDA or other Address Book application.

Notification Outcalls

This ezBlock encapsulates a complete application for initiating Outbound calls for various types of notifications. It allows users to specify various events that would trigger a Notification, and a list of phone numbers that will receive the notification. Examples of notifications can be:

A stock reaching a specified threshold

An operating parameter threshold is reached or exceeded in a manufacturing plant

A Bank account balance threshold is reached

Survey

This ezBlock encapsulates an application to collect User responses to a series of questions comprising a survey. Inbound callers as well as outbound calls that can be placed to a list of phone numbers can answer the Survey. The survey responses are collated and can be presented in a few different formats—eg- Displayed on the web, emailed to the recipient in a spreadsheet or document format, etc.

Voice Forms

This ezBlock encapsulates an application that allows Users to define a ‘Voice Form’. A Voice Form is comprised of a series of questions that callers must answer when they call into the application. The answers can be in the form of DTMF digits, spoken words or phrases, or a recording of a verbal answer. An example of a Voice Form Application is an application to gather registration data from new subscribers to a service. The registration data could include for instance, the Name, Contact phone numbers, Address and a credit card number.

Details on the implementation of the various components of the invention may be found in the attached Appendix.

While the invention has been described in terms of an exemplary embodiment, it is contemplated that it may be practiced with variations that are within the scope of the attached claims.

What is claimed:

1. A interactive voice response system comprising:
a user interface including a plurality of icons each icon representing a respective interactive voice response (IVR) function;
an editor configured to allow a tree structure to be built by graphic manipulation of the icons, the tree structure defining a sequence of IVR functions to be executed by an IVR system; and
an application generator, responsive to the tree structure defined using the editor to generate a voice extended markup language (voiceXML) representation of the sequence of IVR functions represented by the tree.
